(19) United States
(12) Patent Application Publication
(10) Pub. No.: US 2023/0124530 A1
(43) Pub. Date: Apr. 20, 2023

(54) ONLINE PLATFORM FOR CONNECTING USERS TO GOODS AND SERVICES

(71) Applicant: Max NUKI, Newport, RI (US)

(72) Inventor: Max NUKI, Newport, RI (US)

(21) Appl. No.: 17/502,719

(22) Filed: Oct. 15, 2021

(51) Int. Cl. G06Q 30/06; G06Q 30/02

(52) U.S. Cl. CPC G06Q 30/0609; G06Q 30/0201; G06Q 30/0222; H04W 88/02

(57) ABSTRACT

A pre-boarding networked platform includes various technological modules that ready a user or users to receive a good or service. The platform, in some embodiments, assigns a current digital persona to the user, modifies the current digital persona, and matches the modified digital persona to desired goods or services upon the digital persona representing a ready state for the user.

### BACKGROUND

Users purchase, consume, and/or interact with goods and services in a variety of ways. For example, they can enter the physical location of a retailer, and buy a product sold at that location. Also, they may search for items online, and place orders for desired products via online sites. Further, they often engage with a service provider via one mechanism (e.g., an online or digital environment), and access or utilize services via another mechanism (e.g., an in-person performance or event).

At times, a customer, such as a user of a website or mobile application, is presented with many goods/services/experiences provided by multiple different entities within a digital environment, such as an online environment via which the user is in communication with many different entities. Such an online environment can be tricky to navigate, especially when the number of entities to which the user can engage is large or ever increasing.

Thus, a user, when attempting to make a purchase or access a service, experience, or event online, can often encounter issues associated with navigating this complex online world. For example, these issues can cause online transactions and other exchanges to be inefficient and sub-optimal for some, or all, of the parties (e.g., the user, a service provider, a supplier, and so on).

### BRIEF DESCRIPTION OF THE DRAWINGS

Embodiments of the present technology will be described and explained through the use of the accompanying drawings.

FIG. 1 is a block diagram illustrating a suitable network environment within which a pre-boarding platform can be implemented.

FIG. 2 is a block diagram illustrating various components of the pre-boarding platform.

FIG. 3 is a block diagram illustrating a method for pre-boarding a user to receive a good or service within a digital environment.

FIG. 4 is a flow diagram illustrating a method for determining a current persona for an online user.

FIG. 5 is a flow diagram illustrating a method for pre-boarding a user to receive a good or service.

FIG. 6 is a flow diagram illustrating a method for facilitating an exchange of a good or service between a user and an entity.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods for pre-boarding users to interact with others over or via a network environment are described. For example, the systems and methods can be part of a pre-boarding platform, which facilitates and enables transactions between users and other entities (e.g., across different or disparate transaction platforms and digitial environments), such as online service providers, online retailers, online suppliers, and so on.

The pre-boarding platform, in some embodiments, acts to enhance or optimize an online transactional environment, where many different service providers and/or suppliers interact with many different users within the digital space. The pre-boarding platform, therefore, attempts to solve or mitigate issues that arise within the digital environment, such as issues that arise when users are unfamiliar or lack knowledge about a good, service, experience, event, and so on to be provided to them over the network environment.

The pre-boarding platform, then, includes various technological modules that ready a user to receive a good or service, such as modules that utilize various media access and service path navigation equipment or devices. These modules, in some cases, assess a user (e.g., assign a current digital persona to the user), transform the user (e.g., modify the capabilities of the current digital persona), and then match the transformed (or ready) user (e.g., the new or updated digital persona) to desired goods or services.

In effect, the pre-boarding platform enhances, augments, and/or improves a “first mile of service” between users and entities that seek to sell, rent, lease, or otherwise provide goods and services to the users. The platform, in such cases, generates a digital persona, or identity, for a user (regardless of whether the user is seeking to engage with an entity in the digital or physical world), interacts with the digital persona until the digital persona satisfies a ready state, and facilitates transactions between the user in the ready state and the entities, such as service providers, suppliers, retailers, and so on.

The pre-boarding platform, therefore, can act as a technology platform that prequalifies consumers, service professionals, and/or product suppliers to enhance or facilitate the sale of products and services in a digital environment. The platform, being rooted in the digital space, can identify a customer’s current state of mind (e.g., establish and represent them as a digital persona) and move the customer into a pre-satisfied customer, ready to engage professional services and purchase products, among other benefits.

Further, in some cases, the platform provides incentives to selected parties to overcome various barriers (e.g. skill level, psychological comfort, social awkwardness, price sensitivity, and so on), in order to ensure or enhance a desired outcome for an intended service/product transaction within the digital space.

Various embodiments of the system, methods, and/or platform will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Network Environment

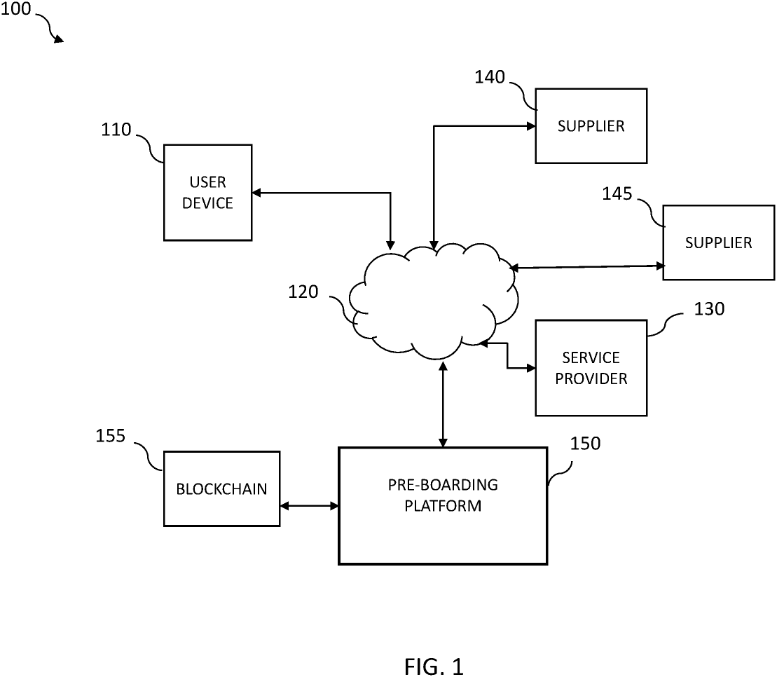

The technology described herein is directed, in some embodiments, to pre-boarding users to receive goods and services over a network, such as a digital or online environment. FIG. 1 is a block diagram illustrating a suitable network environment 100 within which a pre-boarding platform 150 can be implemented.

The pre-boarding platform 150, as described herein, can prepare or ready users, such as consumers, customers, and so on, to receive goods or services from various entities, such as service providers, suppliers, retailers, and so on. For example, the network environment 100 includes a user device 110 associated with a user, which communicates with various a service provider 130 (or providers) and/or suppliers 140, 145 over a network 120, such as a wireless or cellular communications network.

In some cases, the service provider 130 provides a service to the user via their user device 110 (e.g., a digital, virtual, or online service) and/or a real-world service, such as an event, experience, trip, and so on. The suppliers 140, 145, in tandem with, or separate from, the service provider 130, provide goods to the user via their user device 110 and/or within the physical world. For example, the suppliers 140, 145 can sell goods to the user, rent or lease goods to the user, reward goods to the user, create goods for the user, broker the sale of other goods on behalf of the user or a third party, and so on. In some cases, a single entity can act as both a service provider and a supplier.

Further, some or all aspects of the pre-boarding platform 150 can be integrated into, or part of, the suppliers 140, 145, and/or the service provider 130. For example, an online retailer can utilize the techniques described herein to pre-board its own users (e.g., customers, members, and so on) before later selling or otherwise providing goods or services to the users.

As described herein, the pre-boarding platform 150, which can be part of a network server, acts to orchestrate the flow of goods/services/incentives from the various entities (e.g., the suppliers 140, 145 and/or the service provider 130) to the user, often via their user device 110. The pre-boarding platform 150, in some cases, prepares or readies the user to receive the goods and services, by determining a state of the user (e.g., a current state of mind), assigning or creating a digital persona or digital identity for the user, causing the user to perform certain actions to move to a ready state, and then facilitating transactions between the various entities and the user in the ready state.

In some cases, the pre-boarding platform 150 maintains a blockchain database 155 that tracks and facilitates transactions performed by the platform 150. For example, the blockchain database 155, which can be the Ethereum platform, can manage transactions associated with providing users rewards for performing actions prompted by the platform 150, such as rewards that give or mint NFTs (non-fungible tokens) or other token-based rewards to users. Further, the database 155 can manage smart contracts established by and executed on the database 155 in response to transactions performed by the entities and the user over the network.

The pre-boarding platform 150, in some cases, enhances, augments, optimizes, and/or implements a digital workflow or technological hook into a real-world consumer-retailer/provider relationship. The platform 150, by introducing a user as a digital persona or identity, represents the user as a digital entity capable of interacting with other entities over the network 120, as well as morphing into an entity having a ready state to successfully, efficiently, and/or effectively receive goods and services that are desired.

Further details regarding the pre-boarding of users to receive goods and services or perform other transactions with entities over a network environment, such as the network 120, will be described below.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, magnetic or optical cards, flash memory, or other types of media/machine-readable medium suitable for storing electronic instructions.

The network, or cloud, 120 can be any network, ranging from a wired or wireless local area network (LAN), to a wired or wireless wide area network (WAN), to the Internet or some other public or private network, to a cellular system or network (e.g., 4G, LTE, or 5G network), and so on. Further, the user device 110 can be any computing device and/or mobile device, including a smart phone, tablet, laptop, desktop computer, gaming device, and so on. While the connections between the various devices and the network 120 and are shown as separate connections, these connections can be any kind of local, wide area, wired, or wireless network, public or private.

Further, any or all components depicted in the Figures described herein can be supported and/or implemented via one or more computing systems, services (e.g. cloud instances), or servers. Although not required, aspects of the various components or systems are described in the general context of computer-executable instructions, such as routines executed by a general-purpose computer, e.g., mobile device, a server computer, a cloud computer or service, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multiprocessor systems, cloud-based systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Personal Area Network (PAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of the Pre-Boarding Platform

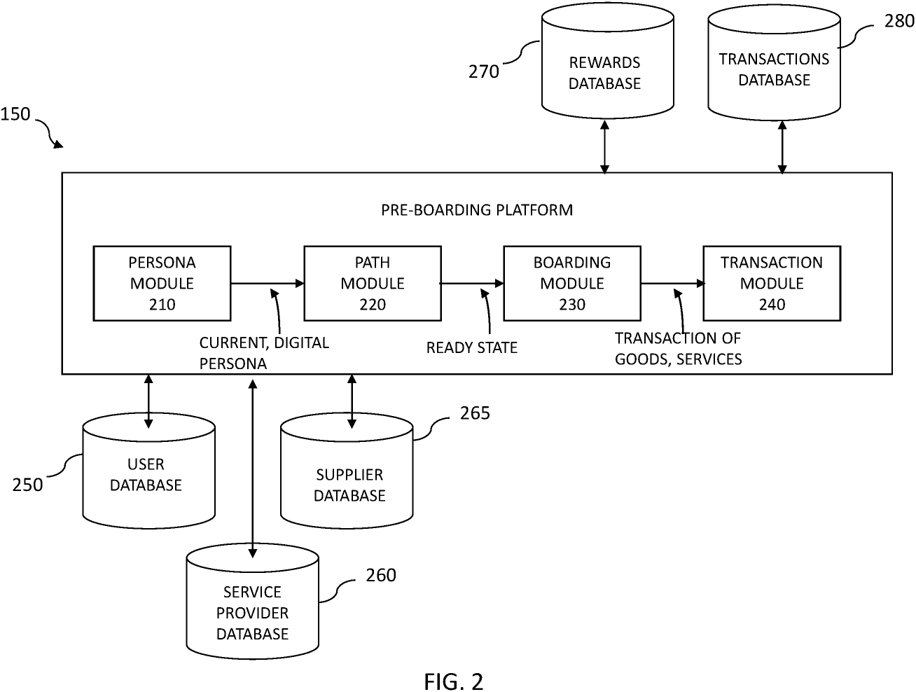

As described herein, in some embodiments, the pre-boarding platform 150 acts to facilitate the provision of goods, products, and/or services to users via a network environment, such as via the network 120. FIG. 2 is a block diagram illustrating various components of the pre-boarding platform 150.

In some example embodiments, the pre-boarding platform 150 may include one or more modules and/or components to perform one or more operations. The modules may be hardware, software, or a combination of hardware and software, and may be executed by one or more processors.

For example, the pre-boarding platform 150 can include or be a system provisioning goods or services to a consumer or other user via an online, networked environment, having a persona module 210, a path module 220, a boarding module 230, and a transaction module 240.

In some embodiments, the persona module 210 is configured and/or programmed to determine a current digital persona for a consumer, other user, and/or a group of users. The digital persona, or digital identity, can be information that represents a compatibility of the user to receive the goods or services from one or more entities associated with the networked environment, such as the suppliers 140, 145 or the service provider 130 over the network 120.

In some cases, the digital persona is generated dynamically when the user expresses interest in the goods or services. For example, the persona module 210 can generate the current digital persona in response to the user accessing a website, application, or online portal associated with providing goods or services, or in response to other triggers, such as the user entering a certain geographical location, the user initiating a request or inquiry into the goods or services, and so on.

In some embodiments, the path module 220 is configured and/or programmed to generate a navigable path to present to the user based on the current digital persona determined for the consumer and determine that the user has achieved a ready state to receive the goods or services based on performance of the set of actions. In some cases, a navigable path includes a set of actions to be performed for or with the user within the networked environment. The ready state, then, is based on the user traversing the navigable path to a pre-determined end point, such as an end point selected from multiple possible end points to which the user can navigate.

In some embodiments, the boarding module 230 is configured and/or programmed to validate the user has achieved the ready state to receive the goods or services and cause the one or more entities providing the goods or services to interact with the user within the networked environment. For example, the boarding module 230 can facilitate a transaction between the one or more entities and the user, such that an entity (or entities) provides the user with a good and/or service during the transaction.

The boarding module 230, via a validation mechanism, can first validate or otherwise authenticate the user to the entities. For example, the boarding module 230 can compare information associated with the user with a database of known or authorized users (e.g., a blockchain database), and validate the user to receive the goods or services from the entities.

As another example, the boarding module 230 can validate the user as a suitable user to receive the goods or services. The boarding module 230 can determine that a digital wallet associated with the user includes enough currency (e.g., digital currency, such as bitcoin or ETH), that the user is associated with an authorized form of payment (e.g., an online payment system or credit card), that the user is old enough to receive the goods or services, that the user is within a location authorized or eligible to receive the goods or services, whether a supplier has sufficient incentives to entiece a user, and so on.

In some embodiments, the transaction module 240 is configured and/or programmed to monitor and score interactions between the one or more entities providing the goods or services and the user over the networked environment. For example, the transaction module 240 can track and store information associated with any transactions that occur between the user and the various entities and/or generate a score for any transactions that result after pre-boarding.

In addition to the various modules that perform processes and/or operations to pre-board users to receive or interact with goods and services, the pre-boarding platform 150 utilizes various databases to data stores to facilitate such operations. For example, the platform 150 can include or be associated with a user database 250 that stores information associated with users (e.g., biographical information, collected data, and so on), a service provider database 260 that stores information associated with service providers (e.g., entity type, types of provided services, access information, and so on), a supplier database 265 that stores information associated with suppliers (e.g., type of supplier, the goods they supply, payment or access information, and so on), and so on.

Further, the platform 150 can include or be associated with databases that monitor, track, and/or review transactions and other interactions between entities over the network 120. For example, a rewards database 270 stores information associated with rewards provided to users when performing actions, such as NFTs or other token-based rewards. Further, a transactions database 280 can store information for transactions facilitated by the platform 150, such as transactions associated with goods or services being provided to the user after the user was pre-boarded by the platform. Of course, the platform 150 can store other types of information in various databases.

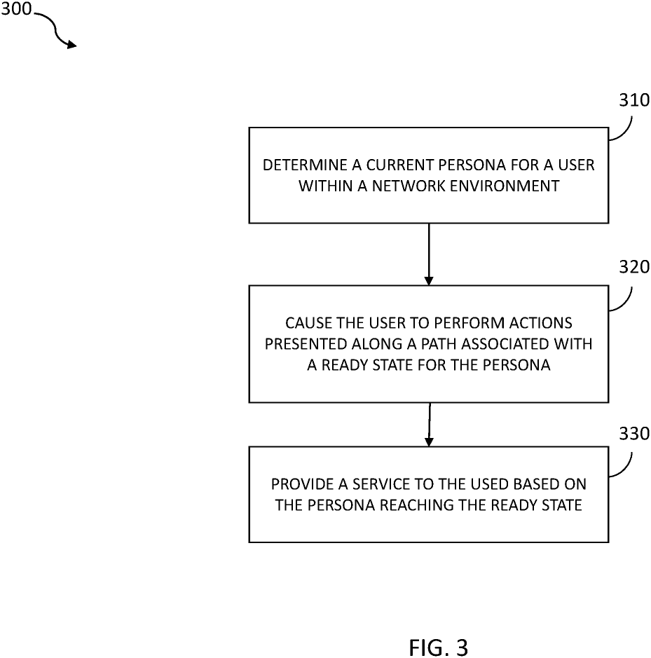

As described herein, the pre-boarding platform 150 can perform various processes, methods, techniques, or operations when facilitating transactions between online or digital entities and users. FIG. 3 is a block diagram illustrating a method 300 for pre-boarding a user to receive a good or service within a digital environment. Aspects of the method may be performed by the pre-boarding platform 150 and, accordingly, is described herein merely by way of reference thereto. It will be appreciated that the method may be performed on any suitable hardware.

In operation 310, the pre-boarding platform 150 determines a current persona for a user with respect to a service provided by an entity supported by a network server. For example, the persona module 210 can determine a current digital persona for the user based on objective data associated with the user and subjective data obtained from the user. In some cases, the digital persona can include or present a metric that measures a readiness of the user to receive specific goods or services and/or a readiness of the consumer to receive goods or services from a specific supplier or specific service provider over a networked environment. The current persona, therefore, can represent the user at a current point in time at which the user engages with an entity over a network.

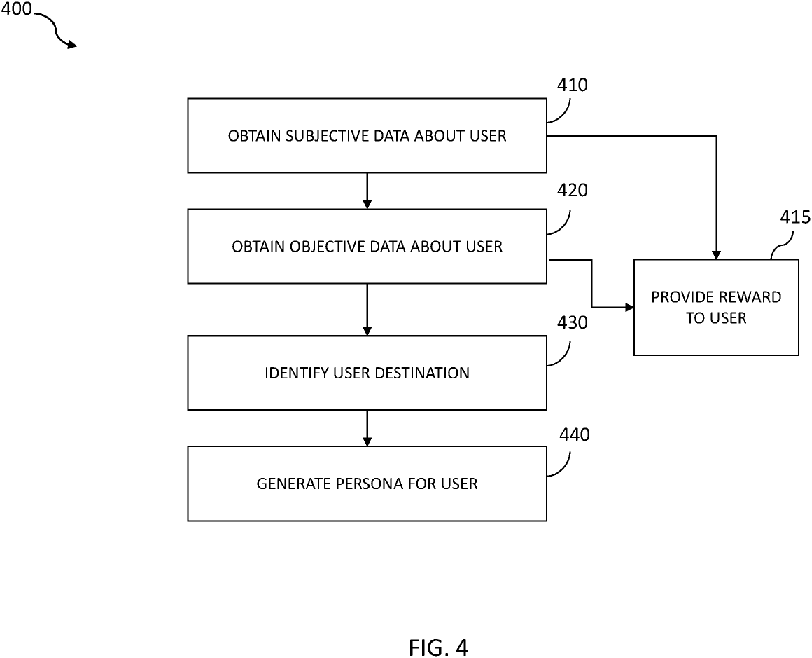

FIG. 4 is a flow diagram illustrating a method 400 for determining a current persona for an online user. Aspects of the method 400 may be performed by the persona module 210 and, accordingly, is described herein merely by way of reference thereto. It will be appreciated that the method may be performed on any suitable hardware.

In operation 410, the persona module 210 obtains subjective data about the user or group of users. For example, the persona module 210, via the platform 150, can present interactive questions or quizzes to the user, such as topic-specific questions or quizzes, and utilize answers to the questions as subjective data for the user. Further, the module 210 can determine incentives to sufficiently entice the user for a potentially successful interaction.

In operation 415, the persona module 210, in response to the user providing an answer or otherwise interacting with the platform 150, presents a reward to the user. For example, the persona module 210 can provide a redeemable gift or discount code for a good or service, can generate an NFT for the user, and so on.

In operation 420, the persona module 210 obtains objective data from the user or group of users. For example, the persona module 210 can obtain or access data associated with the user, such as data stored in the user database 250. The objective data can include biographical information, biometric data associated with the user, user group information, and so on. In response to receiving the objective data (or receiving authorization from the user to obtain objective data), the method 400 may proceed to operation 415, and provide an additional or enhanced reward to the user.

In operation 430, the persona module 210 identifies the user destination, such as the goal, aim, or type of good or service to be provided to the user. For example, the persona module 430 may access information representative of user interactions with the service provider 130 and/or suppliers 140, 145. Also, the persona module 430 can obtain the information directly from the user, or via a mobile application, online portal, and/or physical location accessed by the user.

Thus, the persona module 210 can identify a context of interaction for the user (e.g., physical or online location, time of day, reason for access, and so on), and determine the user’s destination - e.g., to purchase a certain good, obtain a certain service, go to a certain event, have a certain experience, and so on.

In operation 440, the persona module 210 generates a persona for the user or group of users that is based on the subjective data, the objective data, and/or the destination or context information for the user. As described herein, the persona can be a digital persona or identity generated in real-time and dynamically in response to the user initiating an interaction with an entity, a good, a service, and so on. The digital persona, then, is a point in time digital representation of the user, with respect to the goods or services sought after (or determined to be sought after) by the user.

The digital persona can be determined using a variety of mechanisms or frameworks. For example, various metrics can be utilized, such as:
A binary metric that indicates the user is “suitable” or “not suitable” for certain goods or services;
A graded or scaled metric that assigns a grade to the user based on the user’s suitability or compatibility to receive the goods or services (e.g., a number from 1-10, with 10 representing a ready state for the user to receive the goods or services and/or different qualitative grades that represent a determined state of mind for the user);
A multi-factor metric that represents the readiness of the user to receive specific goods or services and/or a readiness of the consumer to receive goods or services from a specific supplier or specific service provider over a networked environment;
A metric that acts as a vector or multi-dimensional (e.g., three-dimensional) point or area on a map associated with the goods or services to be provided to the user. For example, the persona can be a representative point on a map that relates user characteristics to user readiness to receive goods and services; and so on.

The metric, therefore, can be indicative of objective assessments of the user, subjective assessments, or combinations. As described herein, the metric can indicate the user (via their persona) has satisfied a threshold, such as achieving a minimum threshold value and/or being represented by a multi-dimensional vector that ends within an area of a multi-dimensional map of values associated with the threshold.

Example dimensions that can form the vector or mapped characteristics include:
Information that assesses whether the user can afford the service measured in different types of considerations, such as money, points, NFTs or other digital tokens or currencies, and so on;
Information that assesses a user via a targeted or relevant assessment, such as via a first or third party. Example assessment mechanisms include questionnaires, games, quizzes, interactions with professionals or artificial agents/bots, and so on;
Information that represents a desirability rating for the prospective service provider, such as information derived or extracted from social networks, third party services (car share services, online retailers);
Information that is associated with a user’s previous performance on the same or similar service, such as historical information or user patterns; and so on.

Thus, vector space can include some or all of the following dimensions:
a dimension based on an affordability assessment of the user, measured by different types of considerations. (e.g., Money, Points, NFTs or tokens, and so on);
a dimension based on a relevancy assessment measured through actions performed by the user (e.g., quizzes, games, and so on). Example metrics include scores obtained on quizzes, response times within interactions, learning patterns or assessments, and so on;
a dimension based on desirability rating for the service provider; and/or
performance history for the same or similar service or for the same service provider.

Referring back to FIG. 3, the pre-boarding platform 150, in operation 320, causes the user to navigate a path of interactive actions that are based on the current persona determined for the user. For example, the path module 220 generates a navigable path having a set of actions to be performed for or with the user within the networked environment. In some cases, the navigable path includes multiple actions that cause the user to interact with the platform, including a first action that presents an interactive experience to the user and a second action that presents one or more initial goods to be purchased by the user.

The following example illustrates utilization of the platform 150 to navigate the path from a current digital persona to a threshold or suitable digital persona. A service provider desires to acquire (e.g., within the next five days) 200 customers with at least 500 NFT tokens for in-game incentives, intermediary-level experience in baseball-related in-game betting, and an initial assessment of the current interest in purchasing a family pack for the next local game rated at 60%.

Based on these parameters, the system creates a set of service use candidates in a proximal “vicinity” of the desired parameters. As one example, a customer has 250 NFT tokens, entry-level betting experience, and 100% interest in tickets (e.g., he already bought the tickets). To bridge the gap, the platform 150 directs the customer, via the performable actions described herein, to acquire at least 250 NFT tokens and provide interactive training for him to reach the intermediate skill level.

Thus, based on the customers baseball-gaming experience, the platform selects a set of his favorite game choices and invites the customer to train for and participate in a Alrun virtual baseball quiz tournament with prizes ranging from 100 to 10,000 NFT tokens. The tournament lasts for 3 weeknights, and if the customer reaches the quarterfinal bracket of the game and collects over the missing 250 NFT tokens, he is referred to the service provider, and his path is complete. The platform 150, therefore, has selected and presented certain actions that modify the original or current digital persona to a sufficient or suitable digital persona, as requested or targeted by the service provider.

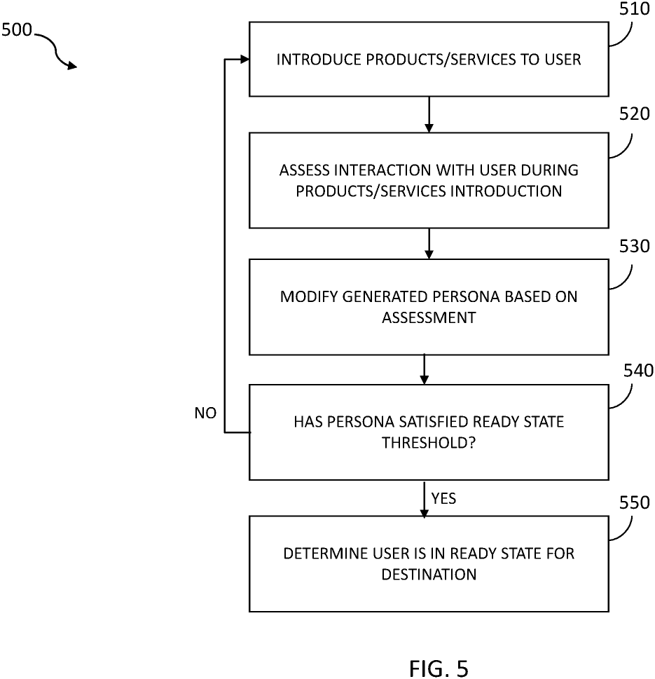

FIG. 5 is a flow diagram illustrating a method 500 for pre-boarding a user to receive a good or service. Aspects of the method 500 may be performed by the path module 220 and, accordingly, is described herein merely by way of reference thereto. It will be appreciated that the method may be performed on any suitable hardware.

In operation 510, the path module 220 introduces products or services to the user. For example, the path module 220, upon receiving information identifying the digital persona generated for the user, introduces an initial set of products or services for the user based on the digital person assigned to the user. These products or services are part of a path of interactions established for the user that enables the user to navigate from the currently assigned persona to a ready state persona to receive the desired goods or services.

In some cases, the path module 220 can expose or introduce goods or services to the user as the user navigates the path. For example, the path module 220 can perform actions that cause the user to interact and learn about the goods or services, such as the types of goods, the types of services, different levels of goods or services, and so on.

In some cases, the path module 220 can stage or queue the actions based on a classification of the user before and/or during navigation of the path (e.g., before or after performance of at least one action). Thus, the path module 220 can classify or group a user based on their readiness to become or act as a prospective customer for services or products (e.g., the user is “low,” medium,” or high” with respect to their readiness for a specific product/service/good).

In some cases, the path module 220 can provide rewards to users as they navigate a path of actions. For example, the path module 220 can provide a reward to the user in response to the consumer performing a portion of the set of actions within the navigable path and/or completing a certain portion of the navigable path.

In some cases, the path module 220 performs pre-boarding actions at or within certain time windows based on the type of actions, the type of services or goods to be provided to the user, and so on. For example, the path module 220 can introduce certain actions at one time, and other actions at a later time, to optimize preparing the user for the requested services or goods.

In operation 520, the path module 220 assesses an interaction between the user and the introduced goods or services. For example, the path module 220 can assess and/or determine whether the user purchased or otherwise received the goods/services, whether the user interacted with the goods/services, and so on.

In operation 530, the path module 220 modifies the digital persona assigned to the user based on the assessed interactions. For example, in response to an initial purchase of the introduced goods or services, the path module 220 can modify the digital persona to indicate the user is closer to a ready state (e.g., the digital persona moves from an assigned “7” to an assigned “8” in response to the user selecting one or more goods associated with a destination service).

In operation 540, the path module 220 determines whether the modified digital persona has satisfied a threshold ready state. If the digital persona has satisfied a ready state threshold (e.g., the point on a map associated with the digital persona has moved to a region on the map associated with the ready state), the method 500 moves to operation 550 and determines the user, via their modified digital persona, is in the ready state to receive the goods or services at the destination.

If the digital persona has not satisfied a ready state threshold (e.g., the digital persona is not assigned a threshold ready state number of “9” or “10), the method returns to operation 510, and additional products or services are introduced to the user (or, in some cases, other actions are performed on behalf of the user). For example, in some cases, the method 500 can determine the user is far from the ready state and introduce remedial or introductory actions to begin the process of modifying the digital persona via other goods or services.

Thus, the method 500, performed by the path module 220, determines the user has achieved a ready state to receive goods or services based on navigation to one or more end points associated with one or more entities providing the goods or services, such as a supplier providing goods to the user. The path is navigated by the user via a series of interactions or actions (e.g., initial purchases or redemptions of goods/services, digital interactions, and so on) to one or more end points associated with boarding the user to receive the desired goods or services from the entities.

Referring to FIG. 3, in operation 330, the pre-boarding platform 150, upon completion of the interactive path by the user, provides the service from the entity supported by the network server to the user. For example, the boarding module 230 can validate the user as a suitable user to receive the goods or services and facilitate a transaction between the one or more entities and the user, such that an entity (or entities) provides the user with the goods and/or services during the transaction.

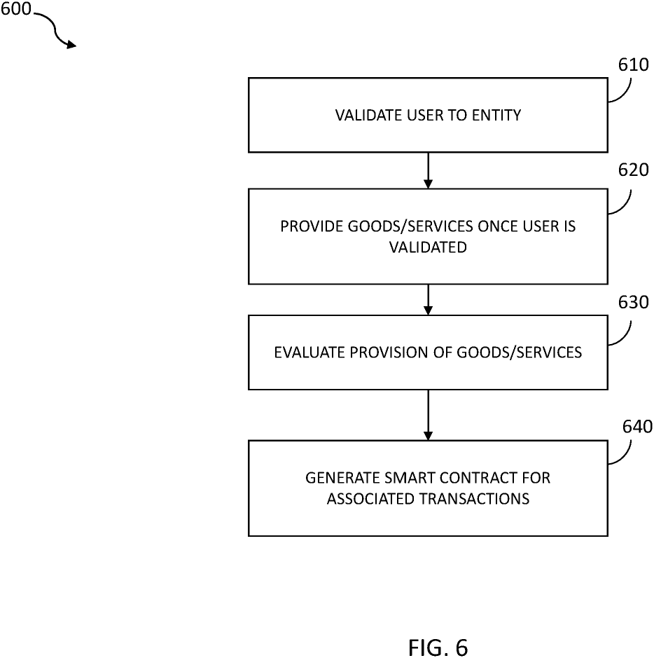

FIG. 6 is a flow diagram illustrating a method 600 for facilitating an exchange of a good or service between a user and an entity. Aspects of the method 500 may be performed by the boarding module 230 and, accordingly, is described herein merely by way of reference thereto. It will be appreciated that the method may be performed on any suitable hardware.

In operation 610, the boarding module 230 validates the user to an entity providing a good or service. For example, the boarding module 230 can compare information associated with the user with a database of known or authorized users (e.g., the blockchain database 155), and validate the user to receive the goods or services from the entities.

In addition, the boarding module 230 can determine that a digital wallet associated with the user includes enough currency (e.g., digital currency, such as bitcoin or ETH), that the user is associated with an authorized form of payment (e.g., an online payment system or credit card), that the user is old enough to receive the goods or services, that the user is within a location authorized or eligible to receive the goods or services, and so on.

In operation 620, the boarding module 230 causes the entity to provide the goods or services to the user once the user is validated. Once goods/services are provided, the transaction module 240, in operation 630, can evaluate the transaction, and in operation 640, generate a contract for the transaction. For example, the boarding module 230 generates a smart contract that represents a transaction between the entity and the user when the user receives the good/service from the entity over the network.

Also, the boarding module 230 can generate a smart contract via the blockchain database 155 (e.g., an Ethereum database) upon determining or matching the user persona to the entities providing the goods and services and execute the smart contract on the database 155 upon a successful agreement to provide the goods or services to the user.

### Example Implementations of the Pre-Boarding Platform

As described herein, the pre-boarding platform 150 performs various operations to convert a user to a ready state to receive goods or services, where the user is prepared to receive the goods or services in an efficient and effective manner. In addition to the example scenarios described herein, the pre-boarding platform 150 can be utilized by many types of entities or service, including professional services (e.g., during a doctor/dentist visit or during a visit to a beauty salon), at a public venue (e.g., at a baseball game where the stadium also provides on location betting, fantasy gaming, or other additional services); during corporate or employee training (e.g., during the onboarding of new employees and/or when preparing them for meetings/projects), and so on.

Further services include one to one visits (e.g., visits with a doctor, dentist, physical therapist, mental health care professional, lawyer, cosmetologist, wedding planner, beautician, dietician, nutritionist, hair stylist, professional coach, and so on);
Small group visits (e.g., yoga, meditation & fitness classes, book clubs, and so on);
Large group visits (e.g., clinical trials, classes, museums, stadiums, events, conferences, company events and retreats, and so on);
Public service interactions (e.g., interactions with government entities, including administration, fire, police, safety, schools, and so on).

Further example scenarios include B2B type services, where the platform facilitates the pre-boarding of a service provider to a service provider that can be public, private, non-government agencies, or non-profit corporate entities (e.g., the pre-boarding of a supplier to the supply chain working as a subcontractor that would require qualifying multiple employees, multiple teams, and/or individuals).

In these scenarios, the platform may provide a Contracts Obligation Table, which stores information when a parameter of the service is fulfilled or when a service is provided. An example table can include a mutual obligations table, which stores information about the mutual obligations: such as obligations within B2B contracts.

The following example scenarios illustrate use of the pre-boarding platform 150 in various situations.

A company has implemented the pre-boarding platform for all video conferences, and integrated pre-boarding content into the meeting agenda. Before the meeting, the video conference platform (e.g., Zoom or Meet) assesses each of the meeting invitees, and based on an assessment of their digital personas (as described herein), presents content specific to their needs represented by their personas. For example, new participants to a standing meeting may first be requested to read information about previous meetings and/or review a short clip of a previous meeting, before they receive an access link to the meeting from the platform.

A user has purchased tickets to see the Seattle Mariners in a week. At the time of the purchase (via the team’s mobile application), the user is presented with a quiz regarding the rules of baseball, in order to assess their level of baseball knowledge. Based on the assessment, the mobile application presents the user with additional content (e.g., information to learn about some of the key players or players on the other team), or provides information about ancillary services (e.g., services to wager on the game or actions within the game, services to purchase items, and so on). The application can time the different pre-boarding actions based on the type of services for which the user is being pre-boarded (e.g., a quiz on the team is presented at the time of ticket purchase, whereas information about food or betting services is presented on game day).

A user is looking for a new beauty salon in their area. Their mobile application presents them with information about price, styles (e.g., photos) and so on. Based on the information, the application presents the user with multiple salons to choose from. At the visit (e.g., one of the salons presented to the user), the application presents hair care products based on the user’s interactions during the salon selection process.

A dad is looking for a dentist for his 8-year old son. They choose a new dentist, and go to the appointment. While the dad is filling out the paperwork for a new patient, an application for the dentist office plays a few videos for the son that depict what the appointment will be about, as well as requests the son to indicate their favorite shows/music. During the appointment, the son is more at ease, because they are familiar with what is going to happen, and the treatment room is playing one of his favorite videos.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

1. A system for provisioning goods or services to a consumer via an online, networked environment, the system comprising:
multiple hardware modules, including:
a persona module that determines a current digital persona for a consumer,
wherein the current digital persona for the consumer includes information that represents a current compatibility of the consumer to receive the goods or services from one or more entities associated with the networked environment;
a path module that:
generates a navigable path to present to the consumer based on the current digital persona determined for the consumer,
wherein the navigable path includes a set of digital actions to be performed for the consumer within the networked environment; and
determines that the consumer has achieved a ready state to receive the goods or services based on performance of the set of digital actions,
wherein the ready state is based on the consumer traversing the navigable path to a pre-determined end point; and
a boarding module that:
validates the consumer has achieved the ready state to receive the goods or services; and
causes the one or more entities providing the goods or services to interact with the consumer within the networked environment based on the validation that the consumer has achieved the ready state.

2. The system of claim 1, wherein the path module generates a navigable path that includes multiple actions that cause the consumer to interact with the system, including:
a first action that presents an interactive experience to the consumer; and
a second action that presents one or more initial goods to be purchased by the consumer.

3. The system of claim 1, wherein the one or more entities include a service provider that provides the services to the consumer and a supplier that provides the goods to the consumer.

4. The system of claim 1, wherein the consumer is a user of a mobile device, and the system interacts with the consumer via communications sent between an online portal associated with an online service provider and the mobile device of the user.

5. The system of claim 1, wherein the persona module determines the current digital persona for the consumer based on objective data associated with the consumer and subjective data obtained from the consumer.

6. The system of claim 1, wherein the current digital persona for the consumer includes a metric that measures a readiness of the consumer to receive specific goods or services.

7. The system of claim 1, wherein the current digital persona for the consumer includes a metric that measures a readiness of the consumer to receive goods or services from a specific supplier or specific service provider over the networked environment.

8. The system of claim 1, wherein the persona module determines the current digital persona for the consumer as a representative point on a map that relates consumer characteristics to consumer readiness.

9. The system of claim 1, wherein the path module determines the consumer has achieved the ready state to receive the goods or services based on navigation to one or more end points associated with the one or more entities providing the goods or services.

10. The system of claim 1, wherein the path module determines the consumer has achieved the ready state to receive the goods or services based on navigation to one or more end points associated with a supplier providing the goods to the consumer.

11. The system of claim 1, further comprising:
a transaction module that monitors and scores interactions between the one or more entities providing the goods or services and the consumer over the networked environment.

12. The system of claim 1, wherein the boarding module performs a validation action before causing the one or more entities to present the goods or services to the consumer.

13. The system of claim 1, wherein the boarding module generates a smart contract between the consumer and the one or more entities in response to a transaction performed between the one or more entities and the consumer.

14. The system of claim 1, wherein the path module provides a reward to the consumer in response to the consumer performing a portion of the set of actions within the navigable path.

15. The system of claim 1, wherein the path module provides a reward to the consumer in response to the consumer completing a certain portion of the navigable path.

16. A method performed by a network server of interacting with a user over a network, the method comprising:
determining a current persona for the user with respect to a digital service provided by an entity supported by the network server;
causing the user to navigate a path of interactive actions that are based on the current persona determined for the user; and
upon completion of the interactive path by the user, providing the digital service from the entity supported by the network server to the user.

17. The method of claim 16, further comprising:
generating a smart contract that represents a transaction between the entity and the user when the user receives the service from the entity over the network.

18. The method of claim 16, wherein the entity includes a service provider that provides the service to the user and a supplier that sells goods to the user during provision of the service to the user.

19. The method of claim 16, wherein the current persona represents the user at a current point in time at which the user engages with the entity supported by the network server.

20. A computerized method of qualifying a user to receive a service over a network, the method comprising:
determining a current persona for the user with respect to a service provided by an entity,
wherein the current persona is based on subjective and objective data associated with the user;
mapping the current persona determined for the user to a three-dimensional persona map that is associated with the service provided by the entity;
causing the user to perform one or more actions to modify the determined current persona;
re-mapping the modified current persona to the three-dimensional persona map that is associated with the service provided by the entity; and
determining the user is qualified to receive the service over the network when the re-mapped modified current persona is within a region of the three-dimensional map associated with qualified users for the service provided by the entity.
